(19) United States
(12) Patent Application Publication
(10) Pub. No.: US 2025/0346730 A1
(43) Pub. Date: Nov. 13, 2025

(54) HIGH THERMAL CONDUCTIVITY STRUCTURE AND METHOD OF MANUFACTURING THE SAME

(71) Applicant: SAMSUNG ELECTRONICS CO., LTD., Suwon-si (KR)

(72) Inventors: Minhyo Ahn, Suwon-si (KR); Woongryeol Yu, Seoul (KR); Hyejin Jang, Seoul (KR); Insub Kwak, Suwon-si (KR); Youngnam Kim, Suwon-si (KR); Sungki Lee, Suwon-si (KR); Hyekyoung Lee, Suwon-si (KR); Sungjun Kim, Seoul (KR); Yong Kim, Seoul (KR); Yoonmin Oh, Seoul (KR); Hyun Woo, Seoul (KR)

(73) Assignee: Seoul National University R&DB Foundation, Seoul (KR)

(21) Appl. No.: 19/004,035

(22) Filed: Dec. 27, 2024

(30) Foreign Application Priority Data
May 7, 2024 (KR) 10-2024-0059736

(51) Int. Cl. C08J 7/04; B29C 70/54; B29C 70/88; B29K 83/00; B29K 307/04; B29L 9/00; B29L 31/34; C08J 5/04; G11B 33/14

(52) U.S. Cl. CPC C08J 7/0423; B29C 70/54; B29C 70/88; C08J 5/042; G11B 33/1406; B29K 2083/00; B29K 2307/04; B29K 2995/0013; B29L 2009/005; B29L 2031/34; C08J 2383/04

(57) ABSTRACT

The present disclosure relates to a high thermal conductivity structure and a method of manufacturing the high thermal conductivity structure. An example high thermal conductivity structure includes a polymer base material, a plurality of carbon fibers positioned in a direction within the polymer base material, and a horizontal thermal conductive layer formed on a surface or both surfaces of the polymer base material. The horizontal thermal conductive layer includes reduced graphene oxide (rGO), a longest length of the rGO is smaller than a spacing between the carbon fibers and the rGO is positioned in a horizontal direction perpendicular to a longitudinal direction of the carbon fibers, and the rGO and the carbon fibers contact each other to form a thermal path.

### CROSS-REFERENCE TO RELATED APPLICATION

This application claims the benefit of Korean Patent Application No. 10-2024-0059736 filed on May 7, 2024, in the Korean Intellectual Property Office, the entire disclosure of which is incorporated herein by reference for all purposes.

### BACKGROUND

Recently, electronic component circuits with highly integrated electronic device elements have been developed, and as a result, the amount of heat generated by the electronic component circuits is increasing. This increase in heat generation in the electronic component circuits causes an increase in internal temperature of electronic devices, which may result in malfunction of semiconductor devices and a change in characteristics of resistors, thereby reducing the lifespan of the electronic devices. Effectively discharging the heat that is generated as described above is becoming an important consideration in product development.

High heat dissipation composites are thermal interface materials and may be used in electronic elements that require various types of heat dissipation structures, including smartphones, computers, storage devices, and solid-state drives (SSDs). A polymer is used as a matrix to ensure flexibility, and a composite of an inorganic material and a carbon material filler is used to ensure a high thermal conductivity. Reduction of a thermal conductivity within a substrate and thermal resistance at an interface is important. The non-orientation of a filler is one of the reasons for lowering the heat conduction efficiency. Considering various applications, it is desired to secure a thermal conductivity at a level of 20 W/Mk or higher.

In addition to high heat dissipation and high thermal conductivity, commercialization suitability is important. In order to secure productivity suitable for mass production, application of the drawing process may be considered. Considering these comprehensive needs, material selection and process development are desired.

### SUMMARY

In some implementations, a high thermal conductivity structure includes a polymer base material, a plurality of carbon fibers arranged in one direction within the polymer base material, and a horizontal thermal conductive layer formed on one surface or both surfaces of the polymer base material and including reduced graphene oxide (rGO), wherein the rGO has a longest length that is smaller than a spacing between the carbon fibers and is arranged in a horizontal direction perpendicular to a longitudinal direction of the carbon fibers, and the rGO and the carbon fibers come into contact with each other to form a thermal path.

In some implementations, a high thermal conductivity structure includes a polydimethylsiloxane (PDMS) base material, carbon fibers having a length of 0.8 millimeters (mm) to 1 mm and an average diameter of 5 micrometers (μm) to 10 μm, and arranged in one direction in the PDMS base material, and a horizontal thermal conductive layer formed on one surface of the PDMS base material and including rGO having an area of 0.5 μm² to 2.5 μm², wherein the carbon fibers have a content of 50 volume % to 60 volume % in the PDMS base material, an average spacing between adjacent carbon fibers is 2 μm to 4 μm, the horizontal thermal conductive layer has a thickness of 8 μm to 11 μm and a surface roughness of 0.3 μm to 0.6 μm, and the high thermal conductivity structure has a thermal conductivity of 150 W/mK to 170 W/mK.

In some implementations, a method of manufacturing a high thermal conductivity structure includes arranging and impregnating a plurality of carbon fibers in one direction in a polymer base material, hardening the polymer base material, cutting the polymer base material including the carbon fibers in a perpendicular direction of the carbon fibers arranged in the one direction, and coating a horizontal thermal conductive layer including rGO on one surface or both surfaces of the cut polymer base material.

In some implementations, a method of manufacturing a high thermal conductivity structure includes arranging and impregnating a plurality of carbon fibers in one direction in a PDMS polymer base material, applying a pressure in a perpendicular direction of the carbon fibers arranged in the one direction, defoaming the polymer base material in a vacuum chamber with an internal pressure of 0.02 MPa to 0.10 MPa, hardening the polymer base material at 50° C. to 80° C., cutting the polymer base material including the carbon fibers in a perpendicular direction to an arrangement direction of the carbon fibers, forming a horizontal thermal conductive layer including graphene oxide (GO) on one surface of the cut polymer base material by a dip coating method by using a prepared GO dispersion, and treating a surface of the horizontal thermal conductive layer including the GO with acid to reduce the GO to form the horizontal thermal conductive layer including rGO.

Additional aspects of implementations, will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of implementations, taken in conjunction with the accompanying drawings.

FIG. 1 illustrates a cross-sectional view of a concept of an example of a high thermal conductivity structure.

FIG. 2A illustrates a scanning electron microscope (SEM) image of a cross section of carbon fibers of an example of a high thermal conductivity structure.

FIG. 2B illustrates an SEM image of a side of carbon fibers of an example of a high thermal conductivity structure.

FIG. 3A illustrates an SEM image of a cross section of an example of a high thermal conductivity structure when a content of carbon fibers is low (30.1 volume %) in the high thermal conductivity structure.

FIG. 3B illustrates an SEM image of a cross section of an example of a high thermal conductivity structure when a content of carbon fibers is high (63.3 volume %) in the high thermal conductivity structure.

FIG. 4A illustrates an example of a size distribution graph of reduced graphene oxide (rGO) when a sonication time in an operation of selecting the rGO is 10 minutes, and an example SEM image of an end of a polymer base material including carbon fibers and a horizontal thermal conductive layer including the rGO formed on the end.

FIG. 4B illustrates an example of a size distribution graph of rGO when a sonication time in an operation of selecting the rGO is 60 minutes, and an example SEM image of an end of a polymer base material including carbon fibers and a horizontal thermal conductive layer including the rGO formed on the end.

FIG. 5 illustrates a cross-sectional view of a concept of an example of a repeated rGO coating process of a high thermal conductivity structure.

FIG. 6A illustrates an example SEM image of a high thermal conductivity structure when rGO coating is performed once, and an example cross-sectional shape image of a specimen using a three-dimensional (3D) micro-shape measurement device.

FIG. 6B illustrates an example SEM image of a high thermal conductivity structure when rGO coating is performed three times, and an example cross-sectional shape image of a specimen using a 3D micro-shape measurement device.

FIG. 6C illustrates an example SEM image of a high thermal conductivity structure when rGO coating is performed five times, and an example cross-sectional shape image of a specimen using a 3D micro-shape measurement device.

FIG. 7 illustrates a view of a concept showing each operation of an example of a method of manufacturing a high thermal conductivity structure.

FIG. 8A illustrates example SEM images of a cross section of a polymer base material including carbon fibers before rGO coating when a pressure is not applied to the carbon fibers arranged in one direction in a perpendicular direction, in a method of manufacturing a high thermal conductivity structure.

FIG. 8B illustrates example SEM images of a cross section of a polymer base material including carbon fibers before rGO coating when a pressure is applied to the carbon fibers arranged in one direction in a perpendicular direction.

FIG. 9A illustrates an example SEM image of a cross section of a cut polymer base material including carbon fibers before performing rGO coating on one surface of the polymer base material, in a method of manufacturing a high thermal conductivity structure.

FIG. 9B illustrates an example SEM image of a cross section of a cut polymer base material including carbon fibers after performing rGO coating on one surface of the polymer base material, in a method of manufacturing a high thermal conductivity structure.

FIG. 10A illustrates an example graph showing a C/O ratio before reduction in an operation of treating a surface coated with GO with acid to reduce GO to form rGO, in a method of manufacturing a high thermal conductivity structure.

FIG. 10B illustrates an example graph showing a C/O ratio after reduction of three hours in an operation of treating a surface coated with GO with acid to reduce GO to form rGO, in a method of manufacturing a high thermal conductivity structure.

FIG. 11A illustrates a perspective view showing an upper surface of an example of a solid-state drive (SSD) case to which a high thermal conductivity structure is applied.

FIG. 11B illustrates a perspective view showing a lower surface of an example of an SSD case to which a high thermal conductivity structure is applied.

### DETAILED DESCRIPTION

Hereinafter, implementations will be described in detail with reference to the accompanying drawings. However, various alterations and modifications may be made to the implementations and thus, the scope of the disclosure is not limited or restricted to the implementations. The equivalents should be understood to include all changes, equivalents, and replacements within the idea and the technical scope of the disclosure.

The terminology used herein is for the purpose of describing particular implementations only and is not to be limiting of the implementations. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the implementations belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the implementations with reference to the accompanying drawings, like reference numerals refer to like components and a repeated description related thereto will be omitted. In the description of implementations, detailed description of well-known related structures or functions will be omitted when it is deemed that such description will cause ambiguous interpretation of the present disclosure. In addition, the terms first, second, A, B, (a), and (b) may be used to describe constituent elements of the implementations. These terms are used only for the purpose of discriminating one component from another component, and the nature, the sequences, or the orders of the components are not limited by the terms. It should be noted that if it is described that one component is “connected”, “coupled”, or “joined” to another component, a third component may be “connected”, “coupled”, and “joined” between the first and second components, although the first component may be directly connected, coupled, or joined to the second component.

A component, which has the same common function as a component included in any one implementation, will be described by using the same name in other implementations. Unless disclosed to the contrary, the description of any one implementation may be applied to other implementations, and the specific description of the repeated configuration will be omitted.

A high thermal conductivity structure of the present disclosure may be applied to electronic devices that require various types of heat dissipation structures, and also to engine covers as a component of automobile internal combustion engines, battery cases for electric vehicles, various home appliances, and inverter materials for solar energy and mechanical equipment.

A high thermal conductivity structure includes a polymer base material 110, a plurality of carbon fibers 120 arranged in one direction within the polymer base material, and a horizontal thermal conductive layer formed on one surface or both surfaces of the polymer base material 110 and including reduced graphene oxide (rGO) 130. The rGO 130 has a longest length that is smaller than a spacing between the carbon fibers 120 and is arranged in a horizontal direction perpendicular to a longitudinal direction of the carbon fibers 120, and the rGO 130 and the carbon fibers 120 come into contact to form a thermal path.

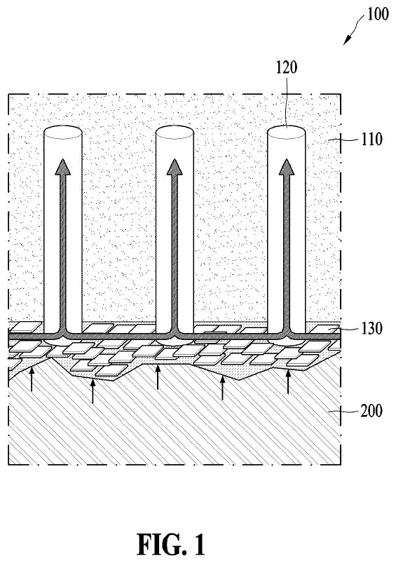

FIG. 1 illustrates a cross-sectional view of a concept of an example of a high thermal conductivity structure 100.

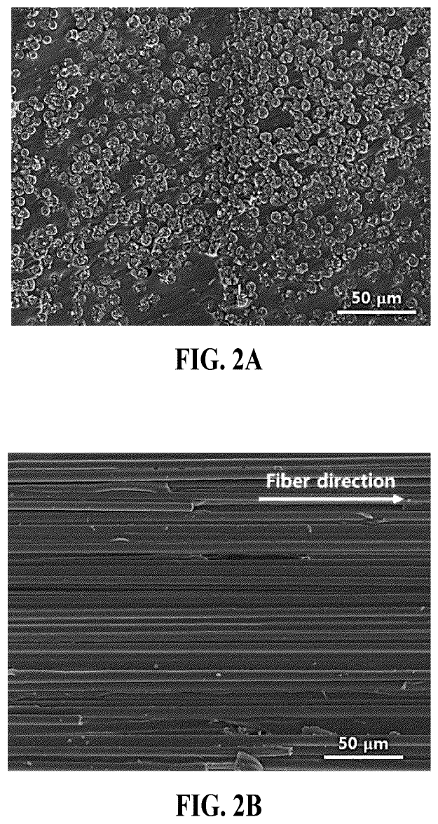

Due to physical and morphological characteristics of carbon fiber, heat transfer in a direction of arrangement of carbon fiber is excellent. According to the high thermal conductivity structure 100 of the present disclosure, a horizontal thermal conductive layer containing the rGO 130 may be introduced to transfer heat in a horizontal direction perpendicular to the arrangement direction of the carbon fibers 120. As shown in FIG. 1, the carbon fibers 120 arranged in the one direction within the polymer base material 110, and the rGO 130 arranged in a horizontal direction perpendicular thereto are arranged to form a horizontal thermal conductive layer. The rGO 130 may be formed in a space between the carbon fibers 120 on a surface of the polymer base material 110. As shown in FIG. 1, the arrangement direction of the carbon fibers 120 and the arrangement direction of the rGO 130 may be perpendicular. FIG. 2A shows that heat transferred from a heat source 200 of the carbon fibers of the high thermal conductivity structure of the present disclosure is not only transmitted in the arrangement direction of the carbon fibers through the carbon fibers 120, but also the heat may be effectively transferred in the horizontal direction, which is perpendicular to the arrangement direction of the carbon fibers, through the horizontal thermal conductive layer including the rGO 130. Therefore, the heat transfer efficiency of the entire high thermal conductivity structure 100 may be improved. The horizontal thermal conductive layer contains graphene in the form of graphene oxide (GO), however, may contain in the form of rGO, which has more excellent heat conduction properties.

FIG. 1 shows that the horizontal thermal conductive layer containing the rGO 130 is formed on one surface of both surfaces of the polymer base material 110, but the horizontal thermal conductive layer containing the rGO 130 may be formed simultaneously on both surfaces of the polymer base material 110. When the horizontal thermal conductive layer containing the rGO 130 is formed simultaneously on both surfaces of the polymer base material 110, a thickness of the horizontal thermal conductive layer containing the rGO 130 may be different depending on heat sources that both surfaces of the polymer base material 110 come into contact with. FIG. 2A illustrates a scanning electron microscope (SEM) image of a cross section of carbon fibers of an example of a high thermal conductivity structure, and FIG. 2B illustrates an SEM image of a side of carbon fibers of an example of a high thermal conductivity structure.

As shown in FIGS. 2A and 2B, the carbon fibers are arranged in one direction. A cross section of each carbon fiber 120 is observed in the SEM image of the cross section, and the arrangement of the carbon fibers 120 in one direction is observed in the SEM image of the side.

According to an aspect of the present disclosure, the polymer base material 110 may include at least one selected from a group consisting of poly (ethylene-co-vinyl acetate) (PEVA), epoxy, polydimethylsiloxane (PDMS), and a vitrimer. The materials described above are provided as examples, and various polymer materials (resins) may be used as long as they do not conflict with the spirit and concept of the present disclosure.

The polymer base material 110 may maintain the carbon fibers 120 to be arranged in a predetermined direction so that the carbon fibers 120 may perform a function of a thermal interface material (TIM) (or a thermal transfer material).

According to an aspect of the present disclosure, the carbon fibers 120 may have a length of 0.2 mm to 2.0 mm.

The length of the carbon fibers 120 may be substantially the same as a thickness of the high thermal conductivity structure 100 of the present disclosure. Since the carbon fibers 120 have excellent thermal conductivity in the longitudinal direction, the heat transfer may occur from one surface to the other surface of the high thermal conductivity structure 100 through the carbon fibers 120 arranged in one direction. For this, the carbon fibers 120 may be connected from one surface to the other surface of the high thermal conductivity structure 100 of the present disclosure without short circuit or disconnection. According to another aspect of the present disclosure, the length of the carbon fibers is not substantially the same as the thickness of the high thermal conductivity structure 100, and the carbon fibers may be thermally connected to other carbon fibers through a heat transfer path.

When the length of the carbon fibers 120 of the high thermal conductivity structure 100 of the present disclosure is less than 0.2 mm, a thermal conductivity in the longitudinal direction may be lowered. When the length of the carbon fibers 120 of the high thermal conductivity structure 100 of the present disclosure is greater than 2.0 mm, that is, when the thickness of the high thermal conductivity structure 100 is greater than 2.0 mm, a thermal resistance of the carbon fibers 120 from a heat source may increase.

The length of the carbon fibers may be 0.4 mm to 2.0 mm, 0.6 um to 2.0 mm, 0.8 mm to 2.0 mm, 1.0 mm to 2.0 mm, 1.2 mm to 2.0 mm, 1.4 mm to 2.0 mm, 1.6 mm to 2.0 mm, 1.8 mm to 2.0 mm, 0.2 mm to 1.8 mm, 0.2 mm to 1.6 mm, 0.2 mm to 1.4 mm, 0.2 mm to 1.2 mm, 0.2 mm to 1.0 mm, 0.2 mm to 0.8 mm, 0.2 mm to 0.6 mm, 0.2 mm to 0.4 mm, 0.4 mm to 1.8 mm, 0.6 mm to 1.6 mm, 0.8 mm to 1.4 mm, or 1.0 mm to 1.2 mm.

According to an aspect of the present disclosure, a content of the carbon fibers 120 may be 40 volume % to 70 volume % of the high thermal conductivity structure 100.

When the content of the carbon fibers 120 in the high thermal conductivity structure 100 is less than 40 volume %, the thermal conductivity of the high thermal conductivity structure 100 may be low, and when the content of the carbon fibers 120 in the high thermal conductivity structure 100 is greater than 70 volume %, a thermal contact resistance may increase due to a high elastic modulus of the carbon fibers 120.

The content of the carbon fibers 120 in the high thermal conductivity structure 100 may be 45 volume % to 70 volume %, 50 volume % to 70 volume %, 55 volume % to 70 volume %, 60 volume % to 70 volume %, 65 volume % to 70 volume %, 40 volume % to 65 volume %, 40 volume % to 60 volume %, 40 volume % to 55 volume %, 40 volume % to 50 volume %, 40 volume % to 45 volume %, 45 volume % to 65 volume %, or 50 volume % to 60 volume %.

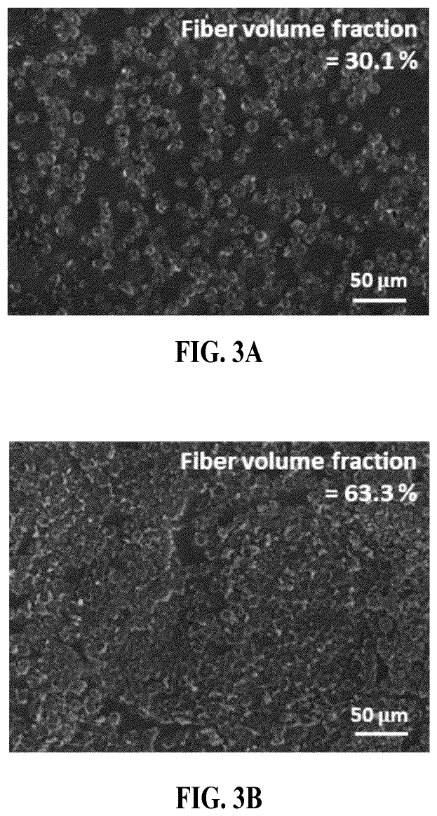

FIG. 3A illustrates an SEM image of a cross section of an example of a high thermal conductivity structure when a content of carbon fibers is low (30.1 volume %) in the high thermal conductivity structure, and FIG. 3B illustrates an SEM image of a cross section of an example of a high thermal conductivity structure when a content of carbon fibers is high (63.3 volume %) in the high thermal conductivity structure. The content in terms of volume % is a value calculated through an area ratio occupied by a carbon fiber cross section within a virtual grid with a predetermined size. When the content of the carbon fibers 120 in the high thermal conductivity structure 100 is low (30.1 volume %, (a)), void portions appear in black on the SEM image of the cross section of the high thermal conductivity structure 100, and when the content of the carbon fibers 120 in the high thermal conductivity structure 100 is high (63.3 volume %, (b)), the number of the void portions appearing in black on the SEM image of the cross section of the high thermal conductivity structure 100 is relatively small. The heat transfer in the arrangement direction of the carbon fibers 120 occurs through the carbon fibers 120. Accordingly, when the content of the carbon fibers 120 in the high thermal conductivity structure 100 is high (63.3 volume %, (b)), the thermal conductivity in the vertical direction is higher.

According to an aspect of the present disclosure, an average diameter of the carbon fibers 120 may be 2 μm to 50 μm, and an average spacing between adjacent carbon fibers 120 may be 1 μm to 10 μm.

A diameter of the carbon fibers 120 may be 2 μm to 50 μm, and when the diameter of the carbon fibers 120 is less than 2 μm, the carbon fibers 120 may be broken or damaged during a process of manufacturing the high thermal conductivity structure 100 of the present disclosure, particularly, a process of arranging the carbon fibers 120 in one direction and applying a pressure in the perpendicular direction of the carbon fibers 120 arranged in the one direction to cause the carbon fibers 120 to be contained in the high thermal conductivity structure 100 in a high content. When the diameter of the carbon fibers 120 is greater than 15 μm, the high thermal conductivity characteristics of the carbon fibers 120 may be deteriorated.

The average diameter of the carbon fibers is 5 μm to 50 μm, 10 μm to 50 μm, 20 μm to 50 μm, 30 μm to 50 μm, 40 μm to 50 μm, 2 μm to 40 μm, 2 μm to 30 μm, 2 μm to 20 μm, 2 μm to 10 μm, 2 μm to 5 μm, 5 82 m to 40 μm, 5 μm to 30 μm, 5 μm to 20 μm, 10 μm to 20 μm, or 5 μm to 15 μm.

The spacing between adjacent carbon fibers 120 may be considered for heat transfer in the horizontal direction that is perpendicular to the arrangement direction of the carbon fibers 120 at an end portion of the carbon fibers 120. A size of the rGO 130 may be determined according to the spacing between the adjacent carbon fibers 120. That is, the size of the rGO 130 may be defined as a longest length of lengths on a plane of a two-dimensional (2D) piece. For example, the size of the rGO 130 may be a diameter in a case of a circle, a long diameter in a case of an ellipse, a diagonal length in a case of a rectangle, and a longest length in a case of an arbitrary shape. The rGO 130 may not be arranged in the horizontal direction between the carbon fibers 120, and therefore, the size of the rGO 130 of the present disclosure may be smaller than the spacing between the carbon fibers 120. The size of the rGO 130 may be determined according to the spacing between carbon fibers 120.

The average spacing between adjacent carbon fibers 120 may be 2 μm to 10 μm, 4 μm to 10 μm, 6 μm to 10 μm, 8 μm to 10 μm, 1 μm to 8 82 m, 1 μm to 6 μm, 1 μm to 4 μm, 1 μm to 2 μm, 2 μm to 8 μm, or 4 μm to 6 μm.

According to an aspect of the present disclosure, the cross section of the carbon fibers 120 may have a major axis that is 100% to 110% of a minor axis.

When the cross section of the carbon fibers 120 is circular, the formation of a heat transfer path at a specific point on the cross section may be reduced, and heat transfer through the carbon fibers 120 may be smooth. In the process of manufacturing the high thermal conductivity structure 100 of the present disclosure, during a process of applying the pressure to the carbon fibers 120 arranged in the polymer base material 110 in a direction perpendicular to the arrangement direction to increase the content of the carbon fibers 120 in the high thermal conductivity structure 100 and/or a process of cutting the polymer base material 110 containing the carbon fibers 120 perpendicularly to the arrangement direction of the carbon fibers 120, the cross section of the carbon fibers 120 may be changed to an elliptical shape by the pressure applied to the carbon fibers 120. The cross section of the carbon fibers 120 of the high thermal conductivity structure 100 of the present disclosure may have the major axis that is 100% to 110% of the minor axis such that the cross section of the carbon fibers 120 approaches a circular shape. In addition, in the process of cutting the polymer base material 110 containing the carbon fibers 120 in the perpendicular direction of the carbon fibers 120 arranged in one direction, when the cutting is not performed perpendicularly to the carbon fibers 120, that is, when the cutting is performed obliquely, the cross section of the carbon fibers 120 may have an elliptical shape. This may refer that the arrangement of the carbon fibers 120 in the high thermal conductivity structure 100 is distorted, and the thermal path at the end of the carbon fibers 120 may be distorted.

According to an aspect of the present disclosure, the rGO 130 may be arranged in a horizontal direction perpendicular to the arrangement direction of the carbon fibers 120, and the rGO 130 and the carbon fibers 120 may come into contact to form a thermal path.

The heat transfer in the vertical direction, which is the longitudinal direction of the carbon fibers 120, is smoothly performed through the carbon fibers 120 arranged in one direction, but in order to increase the heat transfer efficiency of the entire high thermal conductivity structure 100, the heat transfer in the horizontal direction between the carbon fibers 120 is required. The high thermal conductivity structure 100 of the present disclosure includes the rGO 130 for the heat transfer in the horizontal direction, and as described above, the rGO 130 may be arranged in the horizontal direction perpendicular to the arrangement direction of the carbon fibers 120. The rGO 130 at the end of the carbon fibers 120 may form a thermal path in the horizontal direction between the carbon fibers 120, and the heat conduction through this may improve a thermal conductivity of the high thermal conductivity structure 100. FIG. 1 shows that the rGO 130 is connected to each other in the horizontal thermal conductive layer to form a thermal path.

According to an aspect of the present disclosure, the longest length of the rGO 130 may be smaller than the spacing between the carbon fibers 120.

The rGO 130 of the high thermal conductivity structure 100 of the present disclosure is for increasing the thermal conductivity in the horizontal direction that is a direction perpendicular to the vertical direction, in addition to the thermal conductivity in the vertical direction by the carbon fibers 120 arranged in one direction, and the rGO 130 may be filled between ends of the carbon fibers 120 in the horizontal direction. When the longest length of the rGO 130 is smaller than the spacing between the carbon fibers 120, the spacing between the carbon fibers 120 may be filled. Here, the longest length of the rGO 130 is defined as the longest length on the plane of the two-dimensional piece. That is, the longest length may be defined as a diameter in a case of a circle, a long diameter in a case of an ellipse, a diagonal length in a case of a rectangle, or a length connecting two points in a case of an arbitrary shape.

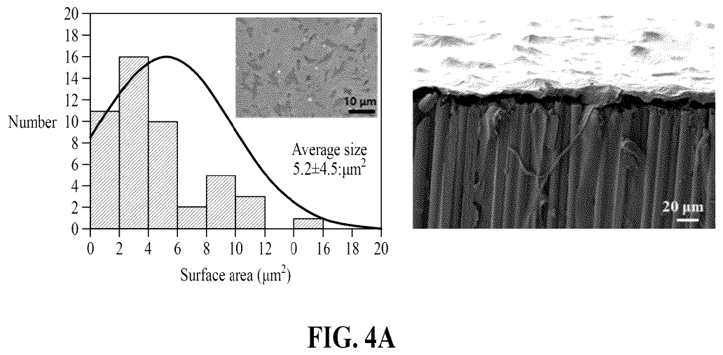

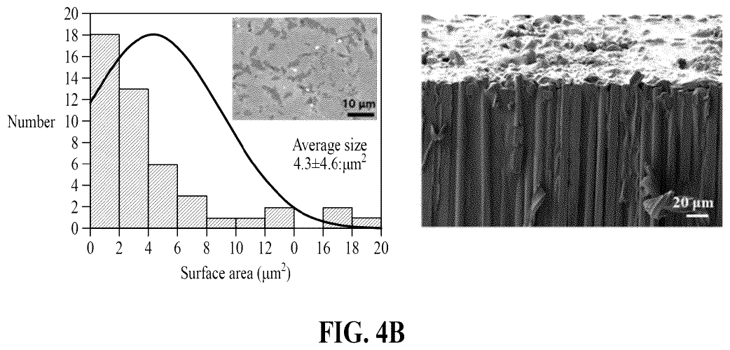

FIG. 4A illustrates an example of a size distribution graph of rGO when a sonication time in an operation of selecting the rGO is 10 minutes, and an example SEM image of an end of a polymer base material including carbon fibers and a horizontal thermal conductive layer including the rGO formed on the end; and FIG. 4B illustrates an example of a size distribution graph of rGO when a sonication time in an operation of selecting the rGO is 60 minutes, and an example SEM image of an end of a polymer base material including carbon fibers and a horizontal thermal conductive layer including the rGO formed on the end.

The size of the rGO 130 may be expressed in length or sometimes in area. FIGS. 4A and 4B show the results of measuring the area, and it is named “average size”.

As shown in the size distribution (average size) graph of the rGO 130 according to sonication time of FIGS. 4A and 4B, as the sonication time increases, the average size of the rGO 130 decreases. When the sonication time is 10 minutes, the average size of the rGO 130 is 5.2±4.5 μm², and when the sonication time is 60 minutes, the average size of the rGO 130 is 4.3±4.6 μm².

As in the SEM images of the end of the polymer base material 110 including carbon fibers and the horizontal thermal conductive layer including the rGO 130 formed on the end of FIGS. 4A and 4B, when the rGO 130 is coated on one end of the carbon fibers 120 formed at equal intervals under the same conditions, it may be confirmed that the horizontal thermal conductive layer is formed so that the rGO 130 adheres more evenly and closely to the end of the carbon fibers 120, in a case where the average size of the rGO 130 is 4.3±4.6 μm², compared to a case where the average size of the rGO 130 is 5.2±4.5 μm². When the rGO 130, which is smaller than the spacing between the carbon fibers 120, is well filled between the carbon fibers 120, the horizontal thermal conductive layer is well connected to the carbon fibers 120 to form a thermal path, and the thermal conductivity of the high thermal conductivity structure 100 increases.

FIGS. 4A and 4B illustrate the sonication as an example of a method of controlling the area of the rGO 130, however, chemical treatment methods, for example, Hummers' method may be used, and the method of selecting the rGO 130 in the present disclosure is not limited to the sonication and the chemical treatment methods.

According to an aspect of the present disclosure, the rGO 130 may have an area of 0.5 μm² to 4 μm². The size is measured in various ways, such as a diameter, a long diameter, and a diagonal length, depending on the shape. Considering the various shapes of the rGO 130, it was measured by area, and as shown in FIGS. 4A and 4B, it may be confirmed that a proportion of the rGO 130 with a small average size increases as the sonication time increases. When the area of the (rGO) 130 is smaller than 0.5 μm², the horizontal thermal conductivity through the rGO 130 may be lowered, and when the area of the rGO 130 is larger than 4 μm², the rGO 130 may not be arranged in the horizontal direction between the carbon fibers 120.

The area of the rGO 130 may be 1 μm² to 4 μm², 1.5 μm² to 4 μm², 2 μm² to 4 μm², 2.5μm² to 4 μm², 3 μm² to 4 μm², 3.5 μm² to 4 μm², 0.5 μm² to 3.5 μm², 0.5 μm² to 3 μm², 0.5 μm² to 2.5 μm², 0.5 μm²to 2 μm², 0.5 μm²to 1.5 μm², 0.5 μm² to 1 μm², 1 μm² to 3.5 μm², 1.5 μm² to 3 μm², or 2 μm² to 2.5 μm².

According to an aspect of the present disclosure, the horizontal thermal conductive layer containing the rGO 130 may have a thickness of 0.5 μm to 20 μm.

The horizontal thermal conductive layer containing the rGO 130 may be manufactured through multiple coatings during the manufacturing process, and a thickness of the horizontal thermal conductive layer may increase according to the number of coatings. Performing the multiple coatings during the manufacturing process of the horizontal thermal conductive layer may be intended to alleviate a roughness of a surface of the horizontal thermal conductive layer.

When the thickness of the horizontal thermal conductive layer containing the rGO 130 is less than 0.5 μm, the surface of the horizontal thermal conductive layer becomes rough, and compared to a case of a smooth surface, the thermal conductivity may decrease due to heat concentration to a specific point, heat dissipation, and increased thermal resistance. When the thickness of the horizontal thermal conductive layer containing the rGO 130 is greater than 20 μm, an effect of hindering vertical heat conduction by the horizontal thermal conductive layer becomes greater than an effect of improving the thermal conductivity of the entire high thermal conductivity structure 100 due to horizontal heat transfer by the horizontal thermal conductive layer, which may deteriorate the thermal conductivity of the high thermal conductivity structure 100.

The thickness of the horizontal thermal conductive layer containing the rGO 130 may be 1 μm to 20 μm, 2 μm to 20 μm, 5 μm to 20 μm, 10 μm to 20 μm, 15 μm to 20 μm, 0.5 μm to 15 μm, 0.5 μm to 10 μm, 0.5 μm to 5 μm, 0.5 μm to 2 μm, 0.5 μm to 1 μm, 1 μm to 15 μm, or 5 μm to 10 μm.

According to some implementations, a surface roughness Rₐ of the horizontal thermal conductive layer containing the rGO 130 may be 0.2 μm to 2.0 μm.

The surface roughness Rₐ of the horizontal thermal conductive layer containing the rGO 130 may be alleviated by repeating the rGO coating several times. When the surface roughness Rₐ of the horizontal thermal conductive layer containing the rGO 130 is less than 0.2 μm, the thermal conductivity of the high thermal conductivity structure 100 may be deteriorated, and when the surface roughness Rₐ of the horizontal thermal conductive layer containing the rGO 130 is greater than 2.0 μm, the thermal contact resistance increases, and the thermal conductivity of the high thermal conductivity structure 100 may be deteriorated.

The surface roughness Rₐ of the horizontal thermal conductive layer containing the rGO 130 may be 0.5 μ m to 2.0 μm, 1.0 μ m to 2.0 μm, 1.5 μ m to 2.0 μm, 0.2 μm to 1.5 μm, 0.2 μm to 1.0 μm, 0.2 μm to 0.5 μm, 0.5 μm to 1.5 μm, or 1.0 μm to 1.2 μm.

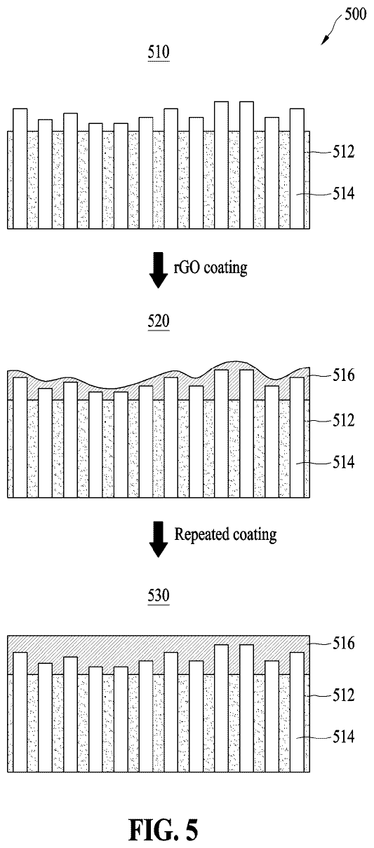

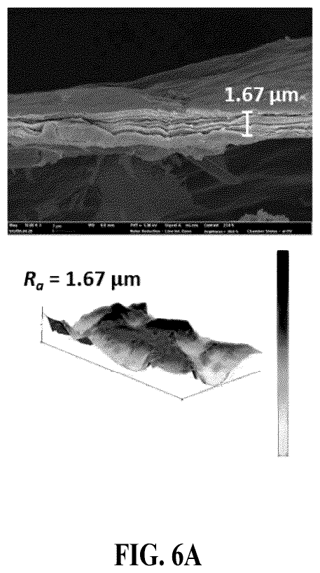

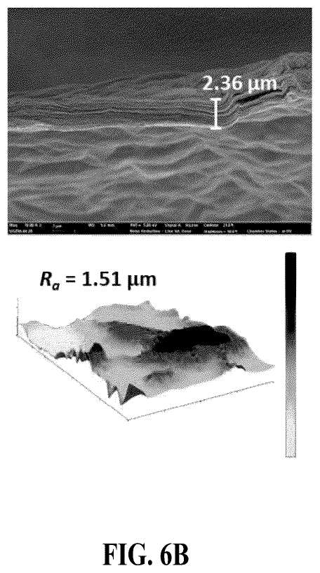

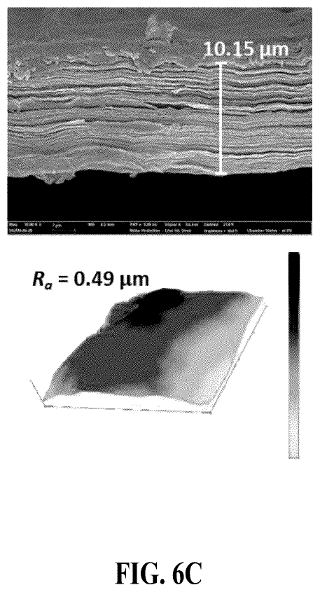

FIG. 5 illustrates a cross-sectional view of a concept of an example of a repeated rGO coating process of the high thermal conductivity structure 100, and FIGS. 6A, 6B, and 6C each illustrate an example SEM image of the high thermal conductivity structure 100 according to the number of rGO coating times (one, three, and five times of coating) and an example cross-sectional shape image of a specimen using a three-dimensional (3D) micro-shape measurement device.

As shown in FIG. 5, the ends of the carbon fibers 514 arranged in one direction on the polymer base material 512 may not be aligned at the same position (state 510). When the rGO is coated in this state, a horizontal thermal conductive layer 516 containing the rGO may be formed in an uneven state along the irregular shape of the ends of the carbon fibers 514 (state 520). When the rGO coating is repeated several times, a surface of the horizontal thermal conductive layer 516 containing the rGO may become gradually flat (state 530). That is, a surface roughness of the horizontal thermal conductive layer 516 may be lowered by repeated coating of the rGO (see FIGS. 6A to 6C). As shown in FIGS. 6A to 6C, the surface roughness is improved by the repeated rGO coating, however the thickness of the horizontal thermal conductive layer may increase.

According to an aspect of the present disclosure, the thermal conductivity of the high thermal conductivity structure may be 30 W/mK to 160 W/mK.

The high thermal conductivity structure 100 of the present disclosure has high thermal conductivity characteristics in a carbon fiber arrangement direction (vertical direction) due to the carbon fibers 120 arranged in one direction, and also has high thermal conductivity characteristics in a horizontal direction (direction perpendicular to the carbon fiber arrangement direction) due to the horizontal thermal conductive layer containing the rGO 130, thereby exhibiting improved high heat conduction characteristics of 30 W/mK to 160 W/mK.

According to an aspect of the present disclosure, the high thermal conductivity structure 100 may be adhesive-free between the rGO 130 and the carbon fibers 120.

The heat conduction performance of the high thermal conductivity structure 100 of the present disclosure depends on smooth thermal contact or bonding of the horizontal thermal conductive layer containing the carbon fibers 120 and the rGO 130 in the horizontal direction perpendicular thereto, and there should be no thermal resistance caused by an adhesive or an adhesive layer for contact or bonding while the contact or the bonding is maintained to ensure a sufficient thermal path. Accordingly, the high thermal conductivity structure 100 of the present disclosure may form a contact or bond between the rGO 130 and the carbon fibers 120 by the rGO coating, and may be adhesive-free, not including an adhesive that may act as a resistance to heat conduction.

A high thermal conductivity structure according to some implementations may include a PDMS base material, carbon fibers having a length of 0.8 mm to 1 mm and an average diameter of 5 μm to 10 μm, and arranged in one direction in the PDMS base material, and a horizontal thermal conductive layer formed on one surface of the PDMS base material and including rGO having an area of 0.5 μm² to 2.5 μm². The carbon fibers may have a content of 50 volume % to 60 volume % in the PDMS base material, an average spacing between adjacent carbon fibers may be 2 μm to 4 μm, the horizontal thermal conductive layer may have a thickness of 8 μm to 11 μm and a surface roughness of 0.3 μm to 0.6 μm, and the high thermal conductivity structure has a thermal conductivity of 150 W/mK to 170 W/mK.

A method of manufacturing a high thermal conductivity structure, the method may include arranging and impregnating a plurality of carbon fibers in one direction in a polymer base material, hardening the polymer base material, cutting the polymer base material including the carbon fibers in a perpendicular direction with respect to an arrangement direction of the carbon fibers, and coating a horizontal thermal conductive layer including rGO on one surface or both surfaces of the cut polymer base material.

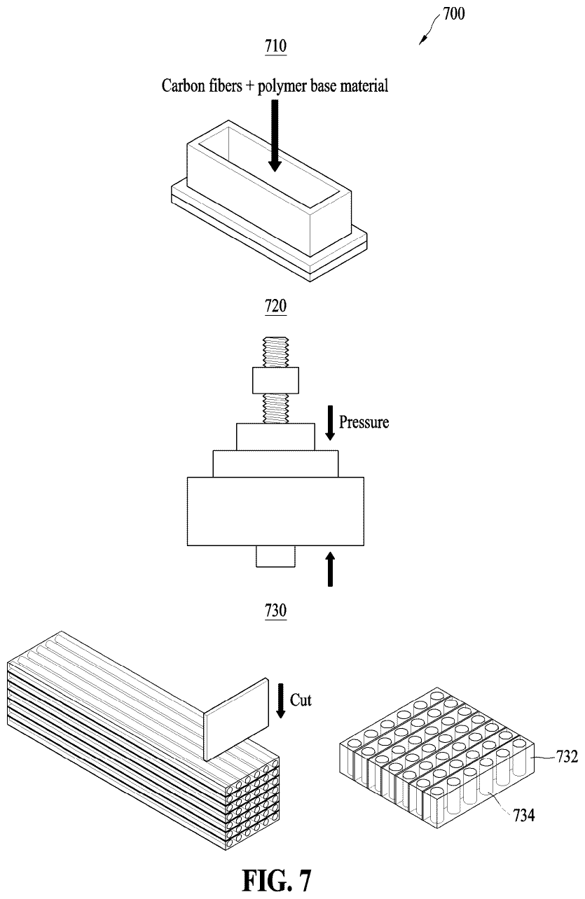

FIG. 7 illustrates a view of a concept showing each operation of an example of a method of manufacturing a high thermal conductivity structure. As shown in FIG. 7, the method of manufacturing the high thermal conductivity structure of the present disclosure may include operation 710 of impregnating carbon fibers in a polymer base material to be arranged in one direction, and then operation 720 of applying a pressure in a perpendicular direction of the carbon fibers arranged in the one direction such that the carbon fibers are arranged more densely. When the pressure is applied in the perpendicular direction of the arranged carbon fibers as described above, the volume % occupied by the carbon fibers in the high thermal conductivity structure of the present disclosure increases. The pressure may be controlled so that the volume % occupied by the carbon fibers in the high thermal conductivity structure is 40 volume % to 70 volume %. The polymer base material impregnated with the carbon fibers arranged in one direction may contain a gas, which may act as a barrier to heat transfer and cause the overall thermal conductivity to be significantly lowered, and thus, it is necessary to remove (defoaming) it. As an example, the method may include defoaming the polymer base material by introducing the polymer base material impregnated with the carbon fibers arranged in one direction into a vacuum chamber with an internal pressure of 0.02 MPa to 0.10 MPa.

The hardening of the polymer base material impregnated with the carbon fibers arranged in one direction may be performed at 50° C. to 80° C. After this hardening process, operation 730 of cutting the polymer base material including the carbon fibers in a perpendicular direction of the carbon fibers arranged in one direction may be performed. The cut polymer base material includes carbon fibers 734 arranged in one direction and a polymer base material 732.

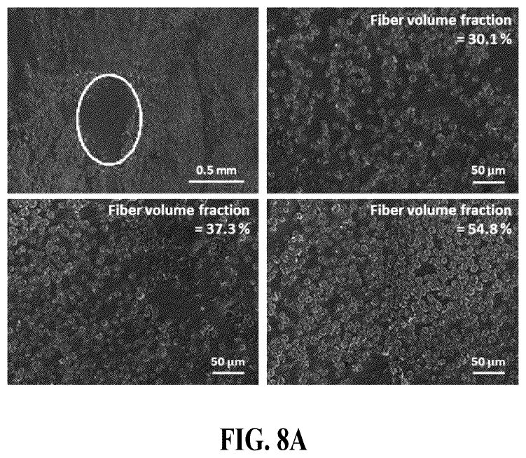

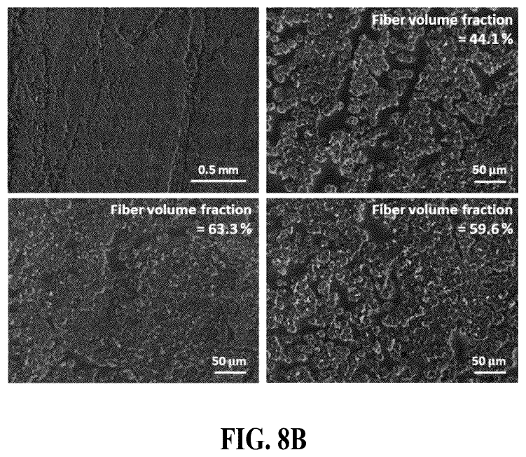

FIGS. 8A and 8B each illustrate example SEM images of a cross section of a polymer base material including carbon fibers before rGO coating when a pressure is not applied to the carbon fibers arranged in one direction in a perpendicular direction and when a pressure is applied to the carbon fibers arranged in one direction in a perpendicular direction, in a method of manufacturing a high thermal conductivity structure. As shown in FIGS. 8A and 8B, when the pressure is not applied in the perpendicular direction to the carbon fibers arranged in one direction, a number of voids are visible in the cross section, large voids also exist, and these voids may cause a decrease in thermal conductivity. When the pressure is applied in the perpendicular direction to the carbon fibers arranged in one direction, it may be confirmed that the number and the size of voids visible in the cross section decrease.

The coating of the rGO on one surface or both surfaces of the cut polymer base material may be performed by coating GO using dip coating, solution casting, spin coating, or spray coating, and reducing it. The above coating method is only provided as an example, and the method of manufacturing the high thermal conductivity structure of the present disclosure is not limited to the above coating methods.

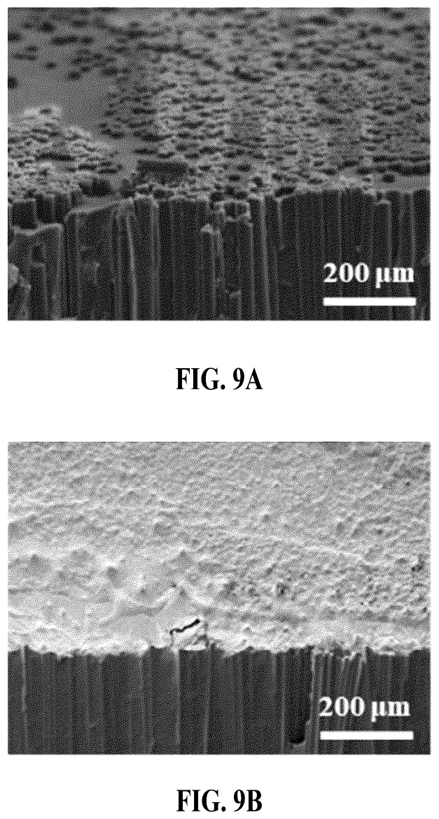

FIGS. 9A and 9B each illustrate example SEM images of a cross section of the cut polymer base material including carbon fibers before and after performing rGO coating on one surface of the cut polymer base material, in a method of manufacturing a high thermal conductivity structure. As shown in FIGS. 9A and 9B, ends of the carbon fibers impregnated in the polymer base material and arranged in one direction may be observed (FIG. 9A), and the coating and formation of a horizontal thermal conductive layer containing the rGO on the ends of the carbon fibers may be confirmed (FIG. 9B).

According to an aspect of the present disclosure, the method may further include, before the coating of the rGO, selecting the rGO having an area of 0.5 μm² to 4 μm².

The rGO is intended to facilitate horizontal heat conduction in addition to vertical heat conduction by the carbon fibers. In order to fill the spacing between the carbon fibers arranged in one direction (perpendicular direction), rGO having a smaller size than the spacing of the carbon fibers may be introduced. The size of the rGO may be controlled in several ways, and in order to introduce the rGO with an area of 0.5 μm² to 4 μm², a selection process may be performed.

In the present disclosure, the sonication has been described as an example of a method of controlling the area of the rGO, however, chemical treatment methods, for example, a method such as Hummers' method, may be used, and the method of selecting the rGO in the present disclosure is not limited to the sonication and the chemical treatment methods.

According to an aspect of the present disclosure, the coating of the rGO may include preparing a GO dispersion, coating the dispersion on one surface of the cut polymer base material, and treating the coated surface with acid to reduce the GO to form the horizontal thermal conductive layer containing the rGO.

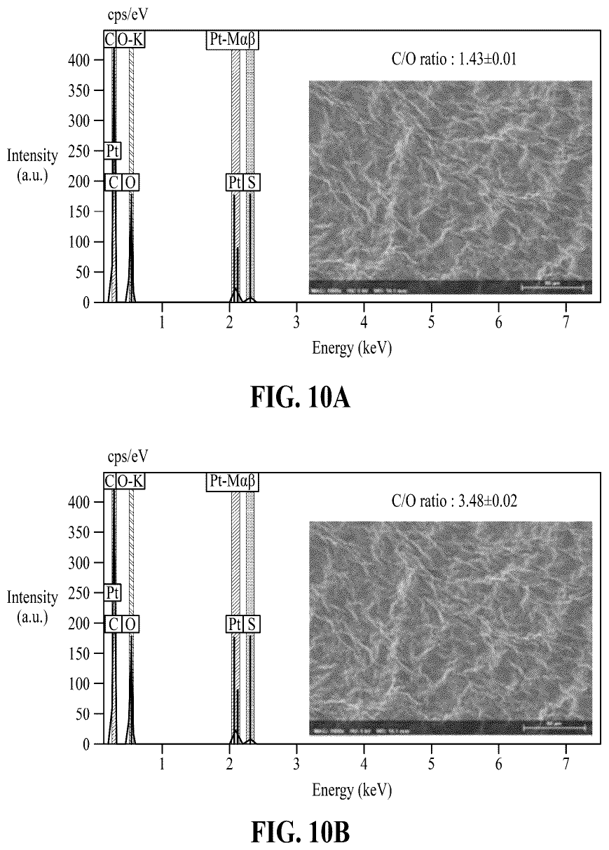

FIGS. 10A and 10B each illustrate an example graph showing a C/O ratio before reduction and after reduction for 3 hours in the treating of the surface coated with GO with acid to reduce GO to form rGO, in the method of manufacturing the high thermal conductivity structure.

As shown in FIGS. 10A and 10B, it may be confirmed that, through a change in C/O ratio, the GO is effectively reduced to rGO through acid treatment. The rGO has greater thermal conductivity than unreduced GO.

The method of manufacturing the high thermal conductivity structure according to some implementations may include arranging a plurality of carbon fibers in one direction and impregnating in a PDMS polymer base material, applying a pressure in a perpendicular direction to the carbon fibers arranged in one direction, defoaming the polymer base material in a vacuum chamber with an internal pressure of 0.02 MPa to 0.10 MPa, hardening the polymer base material at 50° C. to 80° C., cutting the polymer base material containing the carbon fibers in the perpendicular direction of the carbon fibers arranged in one direction, forming a horizontal thermal conductive layer containing GO on one surface of the cut polymer base material by a dip coating method using the prepared GO dispersion, and treating a surface of the horizontal thermal conductive layer containing the GO with acid to reduce the GO to form a horizontal thermal conductive layer containing the rGO.

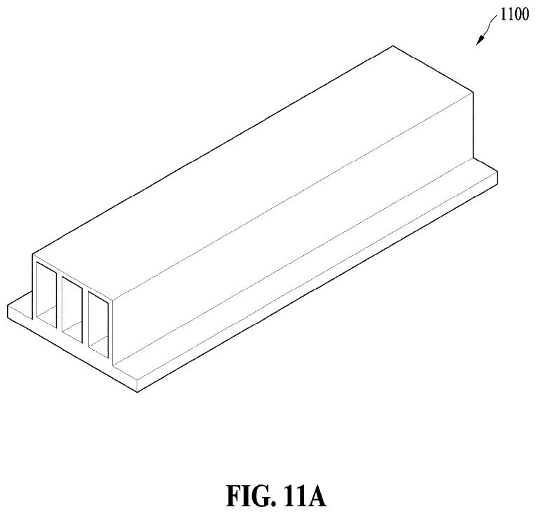

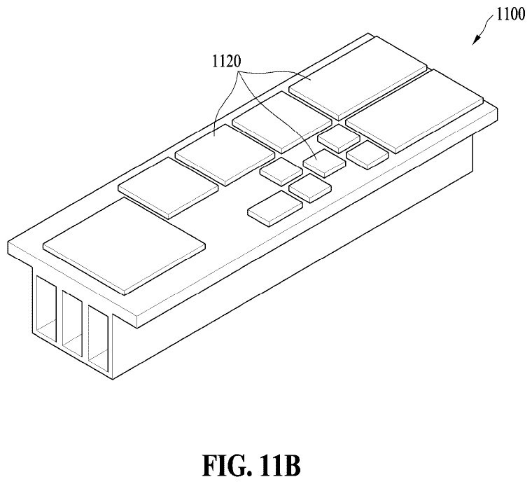

FIGS. 11A and 11B each illustrate perspective views showing an upper surface and a lower surface of an example of a solid-state drive (SSD) case 1100 to which the high thermal conductivity structure is applied. In an SSD requiring excellent heat dissipation, the high thermal conductivity structure of the present disclosure may be applied as a thermal interface material (TIM) of various electronic devices 1120 formed on a substrate 1110. The electronic device may be a resistor, capacitor, inductor, thermistor, oscillator, ferrite bead, antenna, varistor, diode, transistor, or amplifier. However, the application of the high thermal conductivity structure of the present disclosure is not limited thereto, and the high thermal conductivity structure may be applied to a TIM of electronic elements of various heat dissipation components such as a smartphone, computer, storage device, and SSD.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

As described above, although the implementations have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other implementations, and equivalents of the claims are within the scope of the following claims.

What is claimed is:

1. A high thermal conductivity structure comprising:
a polymer base material;
a plurality of carbon fibers positioned in a direction within the polymer base material; and
a horizontal thermal conductive layer formed on a surface or both surfaces of the polymer base material, the horizontal thermal conductive layer comprising reduced graphene oxide (rGO),
wherein a longest length of the rGO is smaller than a spacing between the plurality of carbon fibers, and the rGO is positioned in a horizontal direction perpendicular to a longitudinal direction of the plurality of carbon fibers, and
wherein the rGO and the plurality of carbon fibers contact with each other, thereby forming a thermal path.

2. The high thermal conductivity structure of claim 1, wherein the polymer base material comprises at least one of poly (ethylene-co-vinyl acetate) (PEVA), epoxy, polydimethylsiloxane (PDMS), or a vitrimer.

3. The high thermal conductivity structure of claim 1, wherein the plurality of carbon fibers have a length of 0.2 millimeters (mm) to 2.0 mm.

4. The high thermal conductivity structure of claim 1, wherein the plurality of carbon fibers have a content of 40 volume % to 70 volume % in the high thermal conductivity structure.

5. The high thermal conductivity structure of claim 1, wherein the plurality of carbon fibers have an average diameter of 2 micrometers (μm) to 50 μm, and an average spacing between adjacent carbon fibers is 1 μm to 10 μm.

6. The high thermal conductivity structure of claim 1, wherein a cross section of the plurality of carbon fibers has a semi-major axis that is 100% to 110% of a semi-minor axis.

7. The high thermal conductivity structure of claim 1, wherein the rGO has an area of 0.5 μm² to 4 μm².

8. The high thermal conductivity structure of claim 1, wherein the horizontal thermal conductive layer has a thickness of 0.5 μm to 20 μm.

9. The high thermal conductivity structure of claim 1, wherein the horizontal thermal conductive layer has a surface roughness of 0.2 μm to 2.0 μm.

10. The high thermal conductivity structure of claim 1, wherein the high thermal conductivity structure has a thermal conductivity of 30 W/mK to 160 W/mK.

11. The high thermal conductivity structure of claim 1, wherein the high thermal conductivity structure is adhesive-free between the rGO and the plurality of carbon fibers.

12. A high thermal conductivity structure comprising:
a polydimethylsiloxane (PDMS) base material;
a plurality of carbon fibers having a length of 0.8 mm to 1 mm and an average diameter of 5 μm to 10 μm, the plurality of carbon fibers positioned in a direction in the PDMS base material; and
a horizontal thermal conductive layer formed on a surface or both surfaces of the PDMS base material, the horizontal thermal conductive layer comprising reduced graphene oxide (rGO) having an area of 0.5 μm² to 2.5 μm²,
wherein the plurality of carbon fibers have a content of 50 volume % to 60 volume % in the PDMS base material,
wherein an average spacing between adjacent carbon fibers is 2 μm to 4 μm,
wherein the horizontal thermal conductive layer has a thickness of 8 μm to 11 μm and a surface roughness of 0.3 μm to 0.6 μm, and wherein the high thermal conductivity structure has a thermal conductivity of 150 W/mK to 170 W/mK.

13. A method of manufacturing a high thermal conductivity structure, the method comprising:
arranging and impregnating a plurality of carbon fibers in a direction in a polymer base material;
hardening the polymer base material;
cutting the polymer base material in a direction perpendicular to a direction in which the plurality of carbon fibers are positioned; and
coating a horizontal thermal conductive layer on a surface or both surfaces of the cut polymer base material, the horizontal thermal conductive layer comprising reduced graphene oxide (rGO).

14. The method of claim 13, comprising:
before coating the horizontal thermal conductive layer, selecting the rGO having an area 5 of 0.5 μm2 to 4 μm².

15. The method of claim 13, wherein coating the horizontal thermal conductive layer comprises:
preparing a graphene oxide (GO) dispersion;
coating the GO dispersion on a surface of the cut polymer base material; and
treating the coated surface with acid, thereby reducing the GO and forming the horizontal thermal conductive layer.
